(19) United States
(12) Patent Application Publication
(10) Pub. No.: US 2026/0241567 A1
(43) Pub. Date: Aug. 20, 2026

(54) Systems and Methods for Robotic Package Handling with Multiple Sensors

(71) Applicant: Pickle Robot Company, Cambridge, MA (US)

(72) Inventors: Pace Willisson, Cambridge, MA (US); Gregory Attra, Cambridge, MA (US); Adam Circle, Cambridge, MA (US); Patrick Dingle, Winchester, MA (US); Nathan Huffman, Cambridge, MA (US); Lily Houghton, Boston, MA (US); Benjamin Warwick, Somerville, MA (US)

(73) Assignee: Pickle Robot Company, Cambridge, MA (US)

(21) Appl. No.: 19/164,885

(22) PCT Filed: Mar. 16, 2024
(86) PCT No.: PCT/US2024/020326

§ 371 Date: Sep. 12, 2025

Related U.S. Application Data
(60) Provisional application No. 63/490,915, filed on Mar. 17, 2023.

(51) Int. Cl. B25J 9/16; B25J 13/08; B25J 15/06

(52) U.S. Cl. CPC B25J 9/1679; B25J 13/081; B25J 13/089; B25J 15/0616

(57) ABSTRACT

Improved systems and methods for package handling, for example, in a warehouse logistics robot, include combining data from multiple types of sensors to eliminate uncertainty relating to a grasp point, employing one or more first sensors to perceive an overall workspace and one or more second sensors in a directed fashion to perceive a subset of the workspace with which a robot is about to interact, and picking packages by attempting to reach and grasp a point that is within the bounds of the package rather than on the surface.

### I. PRIORITY CLAIM AND CROSS REFERENCE TO RELATED APPLICATIONS

The present invention is related to, and claims priority from, U.S. Provisional Patent Application Ser. No. 63/490,915, filed on Mar. 17, 2023, the disclosure of which is hereby incorporated by this reference in its entirety

This application also relates to U.S. Provisional Application No. 63/490,317, filed Mar. 15, 2023, entitled “Diffuse Illumination for Robotic Workspaces,” and listing as named inventors Surya Murugavel Ravishankar, Kai Biegun, Ethan Donlon, Noe Fontana, John Huckins, Matthew Pearce and Guang Wen Sun, and U.S. Provisional Application No. 63/490,318, filed Mar. 15, 2023, entitled “Modular Robotic End-Effector and Connector,” and listing as named inventors Chris Fitch and Ville Lehtonen, the entireties of which are hereby incorporated by reference.

### II. FIELD OF INVENTION

The invention disclosed herein relates to methods and devices for robotic package handling, and in particular, use of multiple sensors for improved package perception and picking.

### II. BACKGROUND OF THE INVENTION

In the warehouse logistics industry, there is a push for the use of robotics guided by artificial intelligence algorithms to move and sort packages. This push is a continuation of a general trend of automation in industry and reflects both economic and social pressures to give physically difficult jobs to machines to perform instead of humans. Within the package handling arena there are various subcategories of automation. The current application is particularly concerned with robots in a warehouse environment that are configured to unload trailers of parcels, but the invention disclosed herein has other applications as will be evident to a person of skill in the art.

In the trailer unload use case, packages are often stacked within the trailer such that the robot is approaching a wall of packages to be picked and unloaded. FIG. 1 shows an overhead view of a robot 100 approaching a trailer 110 filled with packages to be unloaded 120. The robot needs to iteratively perceive the wall of packages, segment the wall into individual packages that are candidates for picking, perceive any obstacles in the workspace (such as walls, floor and ceiling), select a package for picking, and then execute the pick and unload.

Warehouse logistics robots rely on various sensors to perceive their environment and detect packages that must be picked and handled, including, for example, digital cameras. One particularly useful sensor for perceiving the full or large part of a scene or workspace is a RGBD camera, which provides color pictures (red-green-blue) as well as depth measurements corresponding to various points in the camera's field of view. As useful as a RGBD camera is, however, it has certain drawbacks that may compromise operation of a warehouse logistics robot. For example, the depth values provided by an RGBD camera may only be accurate to within a number of centimeters. That level of inaccuracy is significant for a robot planning how to interact with packages or other objects within the workspace. To pick or grasp a package, the robot end-effector much generally be brought into contact with the selected package. At the same time, the robot is able to apply large forces through an arm and end-effector, which are high enough to damage packages. The instant disclosure mitigates and addresses these and other issues in the warehouse automation space.

### III. BRIEF SUMMARY OF THE INVENTION

The invention of the instant disclosure includes systems and methods for improved package handling in a warehouse logistics robot configured to pick and handle packages. In one aspect, the current invention combines data from multiple types of sensors. A first sensor (or group of sensors) is used to perceive the overall workspace, while a second sensor (or group of sensors) is used in a directed fashion to perceive a subset of the workspace with which the robot is about to interact. In another aspect, the current invention implements a method of picking packages that attempts to reach and grasp a point that is within the bounds of the package rather than on the surface.

### IV. BRIEF DESCRIPTION OF THE DRAWINGS

FIG. 1 shows a trailer unload robot approaching a trailer to be unloaded.

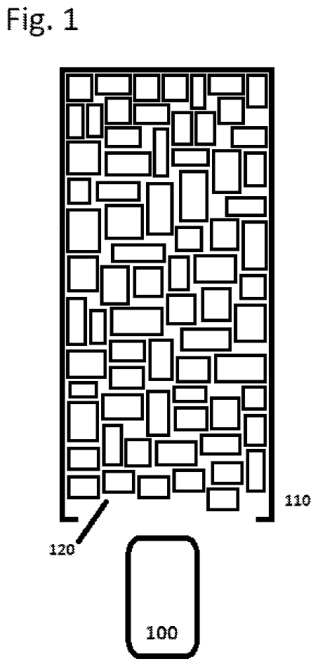

FIG. 2 shows an end-effector with a laser rangefinder.

FIG. 3 shows another view of an end-effector with multiple rangefinders.

### V. DETAILED DESCRIPTION

Techniques described herein pertain to methods for using multiple sensors to perceive and pick packages in a robot workspace environment. Disclosed components may facilitate robot perception of the workspace and prevent or mitigate shortcomings and issues of prior art systems.

### A. Multiple Sensors for Package Perception and Pick

In one aspect, the invention of the instant disclosure comprises a method of using a first sensor to perceive the overall workspace or scene, selecting a package or other object to pick, controlling a robotic end-effector to move it near or within a certain distance of the selected package or object, and using a second sensor to perceive the selected package or object while the end-effector approaches and picks the selected package or object.

In some embodiments, a first sensor may be a stereo RGBD camera, which perceives a color image of the scene comprising the workspace as well as depth or distances. The system may process the color image and depth information to segment and separate individual packages or objects which may be manipulated. In some embodiments, the color image and depth information is processed into a point cloud, which indicates where the faces of all parcels in view are located in space. The system may additionally process the scene data to derive one or more grasp points for each package or object. A grasp point is the point on the surface of the package or object that a robot would target to pick or grasp the package or object.

However, the grasp point measurement and calculation may be relatively noisy for one or more reasons. For example: the first sensor is located at some distance from the objects to be perceived and manipulated; the first sensor is selected for its suitability to perceive the entire workspace and may not be able to simultaneously provide high accuracy measurements throughout the scene; or other reasons. In other words, there is some uncertainty or lack of accuracy in the exact location of the grasp point in space. In one embodiment, using a RGBD camera as a first sensor, the uncertainty in the depth of the grasp point-or distance of the grasp point from the robot-may be in the range of between one and five centimeters.

To account for this uncertainty, the system controls the motion of the end-effector such that the end-effector arrives at a location that is outside the range of uncertainty. In a system where the accuracy of the grasp point derived from data provided by a first sensor is between one and five centimeters, the end-effector may be moved to within five centimeters of the grasp point. At this time, the system may use data from a second sensor that is located on or near the end-effector, which is now in close proximity to the package or object to be handled. In some embodiments, a second sensor may comprise one or more laser rangefinders. A laser rangefinder generally provides much more accurate and precise depth information than a RGBD camera. The system may use data from the second sensor to verify that the end-effector is, in fact, in close proximity to the grasp point of the object to be picked or manipulated. If data from the second sensor indicates that the end-effector is not in proximity with the grasp point, the system may assume that an unexpected error or fault has taken place and may abort the current picking operation or continue to process data from one or more sensors to determine the nature of the error or fault.

If data from the second sensor indicates that the grasp point is in an expected range, the system may determine the location of the grasp point with higher accuracy data from the second sensor and proceed to pick or grasp the package or object with the more accurate determination.

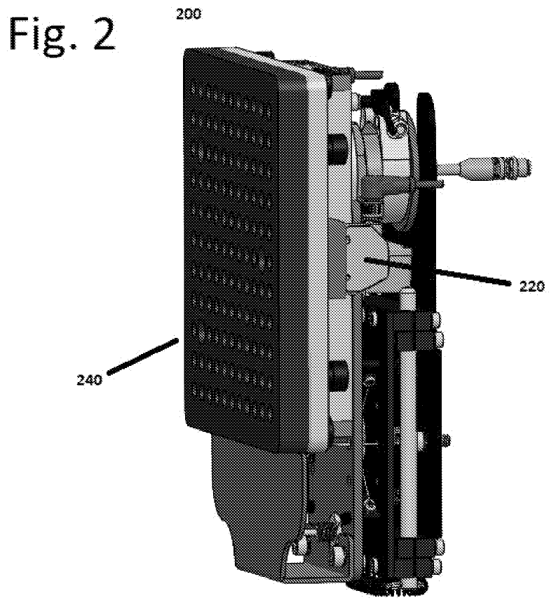

FIG. 2 shows one embodiment of the instant invention. End-effector 200 comprises laser rangefinders 220 and a suction surface 240 for grasping packages. Laser rangefinders 220 are mounted behind the suction surface 240 and measure a distance through a channel that is isolated from the suction chamber.

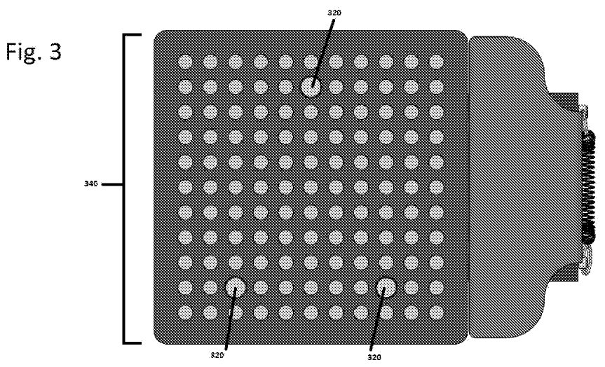

FIG. 3 shows another view of the same embodiment. End-effector 200 comprises a suction surface 340 with holes that connect the vacuum chamber within the end-effector to the suction surface. Channels 320 are isolated from the vacuum system and allow lasers from the laser rangefinders to pass through the suction surface and measure distances.

It should be understood that an RGBD camera is only one type of sensor to which the teachings of this invention may be applied and that laser rangefinders are only one type of second sensor which may be employed. The first sensor or second sensor may be of a different type or a combination of sensor technologies.

In some embodiments, the second sensor may comprise a second RGBD camera or other imaging device mounted on or near the end-effector. Because this device has a vantage point that is closer to the selected package or object, it may provide more accurate depth measurements that will allow the system to better determine the location of the grasp point. This approach may be especially advantageous when the packages to be handled are relatively small. For small packages, the first sensor may not have sufficient accuracy to provide a reliable grasp point. In other words, inaccuracy along all three spatial dimensions may prevent the system from determining a suitable grasp point. Under these circumstances, a second imaging device on or near the end-effector may be employed once the end-effector is in proximity to the selected package to refine or redetermine the grasp point.

In some embodiments, a second imaging device on or near the end-effector may be employed to increase the accuracy of the system's model of the entire workspace. For example, as the end-effector is moved from an initial position to a second position in proximity to a package during a pick operation, the second sensor, which is closer to a number of packages than the first sensor, may collect data regarding packages other than the package selected for the current picking operation.

In some embodiments, a second sensor may comprise a plurality of distance measurement sensors, such as multiple laser rangefinders, mounted at various points on the end-effector. In these embodiments, one or more of the rangefinders may be used to detect the edges of the selected package to ensure that the grasp point for the selected package as determined by the first sensor is suitably located. Multiple rangefinders may also be used to detect the angle of a package face and ensure that the end-effector is approaching the box with a suitable alignment. For a suction end-effector, for example, the surface of the end-effector from which suction is applied should be predominantly parallel to the surface of the selected package. By comparing the distance between the package and end-effector reported by multiple rangefinders, the system can determine how parallel the suction surface is to the package. For example, if the end-effector is approaching a package such that the suction surface is perfectly parallel to the target package, each of the rangefinders would report the same distance. If, however, the distances reported by the rangefinders differ, the suction surface is out of alignment with the package surface and the difference between the alignment of the surface and the alignment of the end effector may be computed and corrected.

In some embodiments, a second sensor may comprise thin “whiskers” disposed around the end-effector that are connected to microswitches or other sensors which detect when one or more of the whiskers is displaced due to contact with some part of the environment such as the target package or an adjacent package. These whiskers may be fabricated from plastic, metal or some other suitable material and may be rigid or semi-rigid.

### B. Open Loop Package Approach

In another aspect, the invention of the instant disclosure comprises a method of picking a package or object in which the end-effector is controlled to move toward a target grasp point that is inside the bounds of the selected package or object. This method may result in a successful picking operation more quickly than other approaches. In existing systems, a robot arm approaches a package to be picked in a closed loop mode, in which the system closely monitors position and system parameters, to avoid crushing the package on approach. However, most packages have at least some compliance and may slightly deform without damage. By targeting a point within the package and approaching that point in an open loop mode, the robot arm may move the end-effector faster.

In some embodiments, the system of the instant invention plans a path for the end-effector from its initial position to a second position within a certain distance of the perceived position of a selected package. In one embodiment, this distance may correspond to the uncertainty or inaccuracy in the measurement of the position of the selected package. The system may then plan a path from this second position to a third position which is located inside or within the bounds of the selected package. As the end-effector moves from the second position to the third position, the system monitors data from the end-effector to determine when a pick has likely been accomplished—i.e., the end-effector has established a mechanical connection with the package.

For example, in some embodiments, the end-effector uses suction to grip or grasp packages and may monitor the vacuum pressure of the system to determine when a pick has been accomplished. In these embodiments, when the suction gripper contacts the package and makes a seal, the air pressure sensed in the vacuum system will go down. When the system determines that a pick was likely successful, it may stop the end-effector and proceed with the desired handling operation. In some embodiments, the communications interface with the robot arm may be optimized such that the end-effector may be quickly halted, as discussed more fully below. In these embodiments, the robot uses a point-to-point mode of operation for the robot arm, which results in faster motion, yet is still able to send a cancel command in mid-motion for execution on the next realtime cycle after the pressure drop is detected.

In some embodiments, the end-effector may sense contact with a package in other or additional ways. The end-effector may have some compliance such that a first piece or first assembly of the end-effector moves with respect to a second piece or second assembly of the end-effector or of the robot arm. For example, when the end-effector encounters an obstacle, the force of the end-effector pressing on the obstacle compresses the first piece or first assembly of the end-effector into a second piece or second assembly of the end-effector. This compression may be sensed by a sensor on or integrated into the end-effector, such as a micro switch or a capacitive sensor. Thus, a sensor detecting compression of the compliant end-effector signals to the system that the end-effector has encountered the package.

### C. Foveated Sensor

In some embodiments, the second sensor may comprise an imaging or distance sensor that is mounted to the chassis of the robot rather than on or near the end-effector. In these embodiments, the second sensor may take higher accuracy measurements, but have a narrower field of view or perception than the first sensor.

In these embodiments, the second sensor could be used to gather additional information about the environment or how the robot is interacting with the environment. For example, in these embodiments, the second sensor could be mounted near the floor or near the ceiling and directed to a package that is in the process of being picked while it is being pulled out of the stack of adjacent packages. In this way, the system could perceive when the package is fully removed from the stack and fully supported by the end-effector.

In some embodiments, a second sensor may be directed at the floor to detect and locate obstacles, including packages that have fallen from the wall or been dropped during picking. In some embodiments, a second sensor may be directed to the location where packages are placed to ensure that packages are placed correctly.

### D. Lidar for Sensing Walls

In some embodiments, a LIDAR scanner is mounted on the robot chassis to measure the distance to obstacles in the environment along a plane that is parallel to the floor. For example, the LIDAR scanner may be mounted underneath the robot chassis. In this position, the LIDAR scanner may detect obstacles, such as dropped packages, that are on the floor between the robot and the wall of packages to be picked.

The LIDAR scanner may also detect the walls of a container in which the robot is working. The system may use a best fit algorithm to between the scan data and two parallel lines to locate the walls of the container and thereby determine the location of the robot with respect to the walls.

### E. Robot Arm Communications Protocol

Robot development and time to market may be shortened by using off-the-shelf components when available and devoting customized development efforts to system hardware and software components for which there is no suitable existing solution. A robot arm is one example of a system component for which suitable third-party off-the-shelf solutions may exist. When using a third-party robot arm (or other active or actuated system component) attention must be paid to the interface between the third-party solution and the customized system.

Robot arm manufacturers such as KUKA and Universal Robots customarily offer an interface to the robot arm that allows the arm to be operated in one of several modes. The operational modes offered by the robot arm manufacturer often abstract away underlying details of the mechanical and/or electrical systems within the arm. For example, in a point-to-point or PTP mode, a robot arm interface may accept coordinates of an end point to which the end-effector should be moved. The robot arm will perform proprietary path planning and motion control algorithms to determine how to implement the motion. Those proprietary algorithms may be based on and take into account detailed specification and performance data—e.g., inertia of the arm components, joint range of motion, maximum torque, etc.—which are not available to the user. A PTP mode may be advantageous because the proprietary PTP algorithms are optimized in these ways for the particular robot arm and therefore yield faster arm motion than other modes of operation.

In these systems, there is often a realtime process to implement and control motion of the arm and one or more non-realtime processes that are responsible for perception, strategy, and system logic. For example, in one embodiment of the instant invention, a first program, which may be referred to as a high level control program and is not a realtime process, makes decisions about how the arm should move. The first program issues instructions to a second program, which may be referred to as an onboard robot control program and also is not a realtime process. The second program communicates with a third program, which may be referred to as an robot arm processing controller and is a realtime process. The third program controls the robot arm motion in real time.

The interfaces between the various programs may add latency to communication. For example, in some embodiments, the interface between the first and second programs may be a network protocol, and the interface between the second and third programs may be via inter-process communication such as shared memory. One of ordinary skill in the art will recognize that the teachings of this disclosure are not dependent on the number of programs in communication.

Problems may arise when one or more of the interfaces over which instructions for robot motion are communicated add a latency that is significant with respect to the desired reaction time of the robot arm. For example, if the network protocol used by the first program to communication with the second program (onboard robot control program) is a connection-oriented protocol with reliability-related overhead, such as Transmission Control Protocol (TCP), the latency in communication between the first and second programs may be on the order of 50 milliseconds (ms) per packet. Often a robot arm must react to its environment faster than such latency would allow. For example, if the robot arm must cancel or abort a movement, the communications protocol adds 50 ms to the reaction time, which may not be sufficient to protect the robot or the environment from a fault condition. In some embodiments described above, a motion cancellation command is used when the robot detects a successful pick. The speed of cancellation in this context is important to minimize the amount of force imparted to the package being picked.

To solve the latency problem and accelerate reaction time, embodiments of this disclosure may implement a lower overhead communication protocol. For example, in some embodiments, a message protocol using a connectionless, best-efforts protocol, such as User Datagram Protocol (UDP), may be employed. However, a best-efforts protocol does not ensure packet delivery or eliminate duplicate packets.

To retain the latency advantage of such a protocol and to mitigate potential delivery failure and duplicate package issues, in some embodiments, the first program sends robot instruction packets which comprise a sequence number. The sequence number starts at a known value and increments for each new motion. Therefore, the second program should only act on a packet when it sees that sequence number has changed from the last sequence number it received. In this way, multiple instruction packets with the same sequence number may be send by the first program to ensure delivery, which the second program can detect duplicate instruction packets as well as ensure execution of instructions in the intended order.

In these embodiments, the streamlined protocol allows instructions to be passed from the first program to the second program and then to the third program for execution within a single realtime cycle of the third program such that the robot's reaction time is greatly accelerated.

In addition, in some embodiments, the system may also gracefully recover if and when the first or second program is rebooted without a complicated initialization. To handle a reboot of one or the other of these programs, each packet mat also contain a boot sequence number. The boot sequence is set to a random number every time the first program restarts. When the second program sees that the number changes, it knows there is a fresh instance of the first program running and the second program should act accordingly, for example, by deleting all instructions sent by the previous instance of the first program.

In the foregoing description, various embodiments have been described. For purposes of explanation, specific configurations and details have been set forth in order to provide a thorough understanding of the embodiments. However, it will also be apparent to one skilled in the art that the embodiments may be practiced without the specific details. Furthermore, well-known features may have been omitted or simplified in order not to obscure the embodiment being described.

1. A method for identifying and picking objects in a robotic workspace comprising the steps of:
providing a mobile robotic system comprising a first sensor, a second sensor, a robotic arm mechanically connected to an end-effector, and a processing subsystem;
receiving, at the processing subsystem, data from the first sensor relating to the workspace;
selecting an object within the workspace to pick based on the data from the first sensor by segmenting and separating individual objects within the workspace that may be manipulated;
processing the data from the first sensor to determine a grasp point and a first location of said grasp point on the surface of the object selected to pick, wherein the first location of the grasp point is associated with a first spatial accuracy parameter and a first corresponding range of uncertainty;
controlling the robotic arm and moving the end-effector to a location that is near the first location of the grasp point but outside the first range of uncertainty associated with said first location of the grasp point;
receiving, at the processing subsystem, data from the second sensor relating to the grasp point of the selected object;
determining, based on data from the second sensor, whether or not the end-effector is in close proximity to the grasp point, and
if the end-effector is within an expected range of the grasp point, determining a second location of the grasp point wherein the second location of the grasp point is associated with a second spatial accuracy parameter and a corresponding second range of uncertainty, and wherein the second range of uncertainty is smaller than the first range of uncertainty, and controlling the robotic arm and moving the end-effector to pick the object based on the second location of the grasp point; and
if the end-effector is not within an expected range of the grasp point, aborting an attempt to pick the selected object.

2. The method of claim 1, wherein the step of providing a mobile robotic system further comprises locating the second sensor on or near the end-effector.

3. The method of claim 2, wherein the step of providing a mobile robotic system further comprises providing a mobile robotic system with a second sensor comprising one or more laser rangefinders.

4. The method of claim 3, wherein the step of providing a mobile robotic system further comprises providing a mobile robotic system with a second sensor comprising a plurality of laser rangefinders.

5. The method of claim 4, wherein controlling the robotic arm and moving the end-effector to pick the object based on the second location of the grasp point further comprises:
receiving, at the processing subsystem, data from the plurality of laser rangefinders;
determining an angle associated with a face of the selected object; and
moving the end-effector to a suitable alignment with the face of the selected object.

6. The method of claim 1, wherein the step of providing a mobile robotic system further comprises providing a mobile robotic system with a first sensor comprising a stereo RGBD camera.

7. The method of claim 6, wherein the first corresponding range of uncertainty is in the range of one to five centimeters.

8. The method of claim 7, wherein the step of controlling the robotic arm and moving the end-effector to a location that is near the first location of the grasp point further comprises moving the end-effector to within five centimeters of the first location of the grasp point.

9. The method of claim 1, wherein selecting an object within the workspace to pick based on the data from the first sensor further comprises processing said data from the first sensor into a point cloud.

10. The method of claim 1, further comprising receiving, at the processing subsystem, data from the second sensor relating to objects within the workspace other than the selected object.

11. The method of claim 1, wherein the step of providing a mobile robotic system further comprises providing a mobile robotic system with a second sensor comprising a plurality of thin rods connected to microswitches that detect when one or more of the thin rods are displaced due to contact with an object in the workspace.

12. The method of claim 1, wherein the second location of the grasp point is located internal to the selected object.

13. The method of claim 12, wherein moving the end-effector to pick the object based on the second location of the grasp point involves moving the end-effector toward the second location in an open loop mode.

14. The method of claim 13, wherein:
providing a mobile robotic system further comprises providing a mobile robotic system comprising an end-effector with a third sensor; and
moving the end-effector to pick the object further comprises monitoring data from the third sensor to determine when the object has been successfully picked.

15. The method of claim 14, wherein the end-effector employs a suction system to pick passages and the third sensor monitors a vacuum pressure of the suction system to determine that the suction system has established a mechanical connection with the selected object.

16. The method of claim 14, wherein providing a mobile robotic system further comprises providing a mobile robotic system comprising an end-effector with a mechanical compliance element and the third sensor comprises one or more of a micro switch and capacitive sensor to detect a mechanical compliance of the mechanical compliance element.

17. The method of claim 14, wherein:
providing a mobile robotic system further comprises providing a communications interface in communication with the processing subsystem and the robot arm and the open loop mode of the mobile robotic system defines a quick halt command; and
moving the end-effector to pick the object further comprises sending the quick halt command from the processing subsystem to the robot arm if data from the third sensor indicates that the object has been successfully picked.

18. The method of claim 1, wherein the step of providing a mobile robotic system further comprises locating the second sensor on a chassis of the mobile robotic system and the second sensor comprises a sensor that provides higher accuracy measurements than the first sensor and has a narrower field of perception than the first sensor.
